(19) United States
(12) Patent Application Publication
(10) Pub. No.: US 2025/0053388 A1
(43) Pub. Date: Feb. 13, 2025

(54) Systems and Methods for an Image-to-Model Converter

(71) Applicant: Nintex UK Ltd., London (GB)

(72) Inventor: Randy Grohs, Meridian, ID (US)

(73) Assignee: Nintex UK Ltd., London (GB)

(21) Appl. No.: 18/227,258

(22) Filed: Jul. 27, 2023

(51) Int. Cl. G06F 8/35; G06F 8/33

(52) U.S. Cl. CPC G06F 8/35; G06F 8/33

(57) ABSTRACT

A method of process model creation. The method may include the steps of receiving the source file, and detecting elements of the source file, including detecting a plurality of objects in an image. The method may further include predicting one or more element types associated with the detected plurality of objects. The method may also include generating, based at least in part on the detected plurality of objects and the predicted element types, an intermediate model, and converting the intermediate model to a process model.

Also, a method of building a machine learning model. The method may include receiving a first set of process diagram training images, and identifying a first plurality of objects within the first set of process diagram training images. The method may also include tagging at least some of the first plurality of objects, and generating predictions of the tagged first plurality of objects.

### FIELD OF USE

This disclosure relates to the field of diagramming business processes and more specifically, to systems, methods, and processes for automatically converting images and image files into digital business-process models that follow recognized modeling language(s) and are also dynamic, functional, and editable.

### BACKGROUND

Professionals in all types of industries often map out an approach to a specific process. This may be done by drawing a process on paper; though given the complexity of and need to revise processes, individuals often use modeling software to draw processes. However, none of these existing tools have: (i) the capability to convert a designed process into a format that follows a standard graphical notation and modeling language (“modeling language”), such as the Business Process Model and Notation language (“BPMN”); nor (ii) the capability to manually make changes to the converted process before finalizing the conversion to align with modeling language and any other desired modeling requirements.

Thus, what is needed are systems, methods, and devices (generally referred to here as “systems”) for automatically converting static images of processes-regardless of the image source or software from which it was created-into digital editable processes that align with desired modeling language. And systems that enable users to revise the converted process to create more accurate and valid processes that follow widely recognized modeling languages.

Such systems will further provide users with converted processes that can be translated into software process components precisely because the processes comply with specific modeling languages.

Overall, such systems will empower users by providing them with a starting point for refining and manipulating a digital process rather than starting from scratch-thus making such systems more efficient over existing technology and saving the user valuable time and resources.

### SUMMARY

The following presents a simplified overview of example embodiments in order to provide a basic understanding of some aspects of the invention. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

Embodiments of this disclosure include a method of process model creation. Such method embodiments may include the steps of receiving a source file and detecting elements of the source file. In some embodiments, the detecting the elements may include detecting a plurality of objects in an image associated with the source file. Method embodiments may further include predicting one or more element types associated with the detected plurality of objects. Method embodiments may also include generating, based at least in part on the detected plurality of objects and the predicted element types, an intermediate model. In some embodiments, the intermediate model may include a construct of a generalized process model. Method embodiments may also include converting the intermediate model to an editable process model.

In some embodiments, the method may include the step of implementing adjustments to the intermediate model. In some embodiments, such implementing may occur before the converting and after the generating. In some examples, the predicted element types may include a first set of element types but not a second set of element types. In some examples, the implementing adjustments may be based at least in part on the second set of element types. In some examples, the second set of element types may include start, end, and intermediate event types. In some embodiments, the implementing adjustments may be based at least in part on enforcing at least one rule.

In some embodiments of the method, the detecting the elements may include identifying one or more layers associated with the elements, and may also include distinguishing the elements based at least in part on the identified layers. In some method embodiments, the layers may include one or more of a custom object layer and a computer vision-lines layer. In some method embodiments, the elements may include one or more of a swim lane, a participant, an arrow, a decorator, an activity, an event, a gateway, a data object, a data store, an annotation, a node connector, a flow, an association, a label, and a filter.

In some method embodiments, the detecting the elements may include detecting a plurality of objects in an image associated with the source file. Some method embodiments may also include the step of identifying what of the detected plurality of objects correspond to at least one known predicted object with a confidence level exceeding a threshold. Some method embodiments may also include the step of subtracting the identified detected plurality of objects that correspond to the at least one known predicted object with the confidence level exceeding the threshold. And some method embodiments may also include the step of visually highlighting the remaining detected plurality of objects.

Some method embodiments may also include the step of refining the process model, wherein the converting comprises creating the process model in an editable format. In some method embodiments, the refining may include hosting/displaying the process model in the editable format together with an image associated with the source file. In some embodiments, the source file may include the one or more images. In some embodiments, the selecting the source file may include selecting one or more images to extract from the source file. And in some method embodiments, the detecting the elements of the source file may include separately detecting elements of each of the extracted one or more images.

In some method embodiments, the predicting may include analyzing at least one of the locations of the elements, sizes of the elements, proximity of the elements to each other. And in some method embodiments, the predicting may further include assigning a confidence factor based at least in part on the analyzing. And some method embodiments may include the step of selecting a source code library. Additionally, in some method embodiments the converting may be based at least in part on the selected source code library. In some method embodiments, the process model may include, or be, a BPMN model. For reference, BPMN is a business-process diagram standard that facilitates better communication between departments within an organization. BPMN process models may include graphical representations of components, which may be connected, and which may be categorized into different groups. While such components and groups may vary for other process modeling paradigms, in the case of BPMN, flow objects may include activities, events, gateways, and/or artifacts. Activities may represent the performing of tasks. Tasks may be single actions in business processes. Events may indicate when some event occurs at the start, end, or during a process (as opposed to when some task or activity is performed by the process). Artifacts may indicate start events of processes, intermediate events, and/or end events. Group objects may show a grouping of activities. Annotations or comments may explain parts of a process. Connecting objects may be lines showing an order or sequence of performing activities, or relationships (e.g., between artifacts and flow objects). Pools may represent companies or organizations, while swim lanes may represent participants within a company, showing who is responsible for process parts. Gateways may require choices, followed by split paths. BPMN, however, is just one example of a process model with specialized notations and applications, for which existing tools are inadequate, not sufficiently tailored, and inefficient in many respects.

Embodiments of this disclosure also include a non-transitory, computer-readable medium having stored thereon computer-readable instructions that when executed by a computing device cause the computing device to perform certain operations. For example, some non-transitory, computer-readable medium embodiments may cause the computing device to receive a source file, and detect elements of the source file. In some embodiments, the computer-readable medium causing the computing device to detect elements of the source file may also cause the computing device to detect a plurality of detected objects in an image associated with the source file. Some non-transitory, computer-readable medium embodiments may also cause the computing device to predict one or more element types associated with the detected elements. Some non-transitory, computer-readable medium embodiments may also cause the computing device to generate, based at least in part on the detected elements and the predicted element types, an intermediate model. In some embodiments, the intermediate model may include a generalized process model construct. And some non-transitory, computer-readable medium embodiments may also cause the computing device to convert the intermediate model to an editable process model.

Some non-transitory, computer-readable medium embodiments may also cause the computing device to implement adjustments to the intermediate model. In some embodiments, such adjustments may be implemented before the intermediate model is converted to a process model. In some embodiments, such adjustments may be implemented after the intermediate model is generated. In some non-transitory, computer-readable medium embodiments, the predicted element types include a first set of element types but not a second set of element types.

In some non-transitory, computer-readable medium embodiments, the implementing adjustments may be based at least in part on the second set of element types. In some embodiments, the second set of element types may include start, end, and intermediate event types.

Embodiments of this disclosure also include a computing device having a processor; a memory; and a non-transitory, computer-readable medium operably coupled to the processor. The computer-readable medium may have computer-readable instructions stored thereon that, when executed by the processor, cause the computing device to perform certain functions or operations. Computing device embodiments may also be caused to receive a source file, and detect elements of the source file. In some embodiments, the computing device embodiments, caused to detect elements of the source file, may also be caused to detect a plurality of detected objects in an image associated with the source file. Computing device embodiments may further be caused to predict one or more element types associated with the detected elements. Computing device embodiments may further be caused to generate an intermediate model. In some embodiments, the intermediate model may include a construct of a generalized process model. In some embodiments such generating may be based at least in part on the detected elements and the predicted element types. Computing device embodiments may further be caused to convert the intermediate model to an editable process model.

Some computing device embodiments may implement adjustments to the intermediate model. Some computing device embodiments may implement such adjustments before the intermediate model is converted to a process model. Some computing device embodiments may implement such adjustments after the intermediate model is generated.

Still other advantages, embodiments, and features of the subject disclosure will become readily apparent to those of ordinary skill in the art from the following description wherein there is shown and described a preferred embodiment of the present disclosure, simply by way of illustration of one of the modes best suited to carry out the subject disclosure. As will be realized, the present disclosure is capable of other different embodiments and its several details are capable of modifications in various other embodiments all without departing from, or limiting, the scope herein.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a functional flow diagram generally illustrating an embodiment associated with creating a process model, in accordance with aspects of the disclosure.

FIG. 2 is a block diagram generally illustrating an embodiment associated with creating a process model, in accordance with aspects of the disclosure.

FIGS. 3A-3C are block diagrams generally illustrating embodiments associated with creating a process model, in accordance with aspects of the disclosure.

FIGS. 4A-4E illustrate aspects of intermediate model creation and/or generation, in accordance with aspects of the disclosure.

FIGS. 5A-5C illustrate aspects of intermediate model creation and/or generation, in accordance with aspects of the disclosure.

FIGS. 6A-6H illustrate aspects of process model creation and/or generation, in accordance with aspects of the disclosure.

FIG. 7 is a flow diagram generally illustrating a method of process model creation, in accordance with aspects of the disclosure.

FIG. 8 is a flow diagram generally illustrating a method of building a machine learning model, in accordance with aspects of the disclosure.

FIG. 9 illustrates a system, in accordance with aspects of the disclosure.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Existing tools for creating and managing process diagrams (such as Visio, Draw.IO, or LucidChart) are primarily concerned with the creation of process diagrams as drawings, and offer inadequate governance. The lack of specialized tools for creating particular types of process method diagrams often requires users to find and use several different tools, which may be time-intensive and require several different actors. For example, a business analyst may create a diagram representing a business process, which a programmer then has to use business process execution language (BPEL) code in business orchestration software to map a BPMN-based diagram of the implemented process for review by an executive. The results are inefficiencies, wasted resources, and potential miscommunications between actors.

In addition, existing or external tools (e.g., Visio/LucidChart) may simply support graphical diagramming alone, consisting essentially of an image of a process diagram. Further, existing tools are general-purpose and may be unspecialized to specific modeling language (such as, e.g., BPMN). Such tools support only their own (often proprietary) formats for storing and creating various types of diagrams. Accordingly, users are limited to the same general purpose drawing tool to create all the different diagram types. But the diagram types may be saliently distinct in many ways—varying from, e.g., an office-space-planning diagram, an org-chart diagram, a brainstorming diagram, a mind-map diagram, etc.

Moreover, the diagram resulting from such general-purpose tools is normally just a bare diagram or image. And such bare diagrams and images are normally incapable of supporting simulation. Therefore, arguably, such diagrams and images are not true process models (e.g., capable of simulation).

In contrast, aspects of the disclosure focus instead on a “process-centric” solution of process management, within which context diagrams are relevant. Aspects of the disclosure may also support true process modeling. For example, instead of storing diagrams as a collection of general-purpose shapes, some embodiments described herein may store diagrams as purpose-built process-models that align with specific modeling languages. In some embodiments, each process activity, event, gateway, message, data-store, or data-object may carry with it a set of metadata, documentation, performance-goals, etc. Unlike simple diagrams on a canvas, such process model embodiments may be validated for process rule conformance, and support advanced features such as model simulation, thereby improve process modeling.

In addition to the images and image files discussed above, are diagram files created with external tools may also have embedded data structures that are generally descriptive of diagram elements and their position on the page, and represent shapes, connectors, etc. In such cases, whether the source data structures are serialized into XML, JSON, or other formats, aspects of the disclosure may convert a static diagram image and source data schema into a data model (e.g., an interactive model and/or a BPMN 2.0 data model). More generally, some embodiments may involve storing related diagrams as data structures interpretable and convertible without the use of image conversion, and relatedly not entail computer vision algorithms.

On the other hand (and alternatively or additionally), computer vision (“CV”) techniques may be utilized to detect different kinds of elements in an image. For example, aspects of the disclosure relating to conversion embodiments may be applicable to a variety of image files, or images that are embedded into other documents (e.g., WORD, PDF, etc.). Some such images files (e.g., a “process image”) may even be the result of a hand-drawn diagram that has been captured via camera or other scanning device. In some embodiments, such a hand-drawn diagram may be represented as a collection of pixels, organized into rows. Relatedly, a raster image may consist of a variable number of fixed-width rows of pixels, where each pixel represents a color at a specific position. In such cases that generally lack data structures encoded in such image formats to convert (e.g., into BPMN format, etc.), CV techniques may be useful.

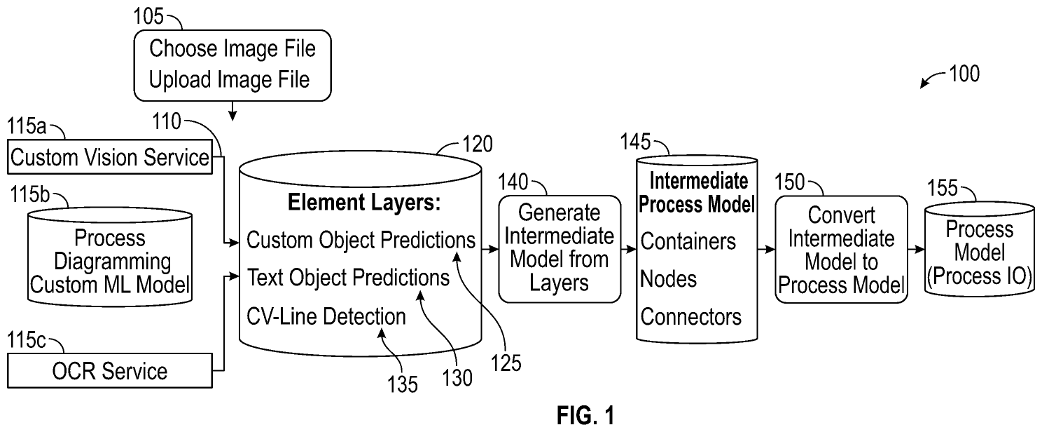

FIG. 1 is a functional flow diagram 100 generally illustrating an embodiment associated with creating a process model, in accordance with aspects of the disclosure. In some examples, an initial method step may be to select a file 105, to be imported, or to be extracted from a document file. Process embodiments may involve an intermediate user-interface that provides a way for a user to specify which image elements in the document should be used as source images. For instance, a specialized user interface may permit selecting images from a PDF or WORD document for conversion. If the source file is an image file, the image file may be selected and uploaded as the source image. If the source file is a PDF or WORD document, one or more images can be extracted from the document and used as the source for the image conversion. In some embodiments involving certain types of such document files, one or more steps may be required to extract the one or more images e.g., where the one or more images may be embedded in the documents.

In some examples, the selected file may originate or be received 110 from one or more sources 115a-c, such as a custom vision service (e.g., Azure™ Cognitive) 115a, a process diagram custom machine learning model 115b, or an optical character recognition (“OCR”) service (e.g., Azure™ form recognizer) 115c. In some user interface embodiments, the file and/or image selection(s) may be confirmed to the user (e.g., displaying image elements for the user to select, and using a colored rectangle to indicate that the user has drawn a rectangle around the diagram in the document). In some examples, once valid source images have been obtained, the process may proceed on each source image.

In some examples, a next method step may include detecting objects, or elements 120, (using, e.g., an image detector) within the source file, including detecting element layers. There may be many different categories of elements to be detected and each type of element may use a different type of computer vision algorithmic approach for detection. In most embodiments, the process being created will follow pre-determined modeling language; thus, the specific elements being detected in the images will be informed by pre-existing diagramming standards as defined in the modeling language's specification. For example, some embodiments may have the objective of creating a BPMN 2.0 model and thus be informed by BPMN diagramming standards. BPMN element descriptions and categories may accordingly impact operations when synthesizing a BPMN process model from an image or photo. Related embodiments and techniques may be expanded to include every element defined in the BPMN specification, and related elements and sets of indicators may be detected in the source image.

In one next method step embodiment, a layered element collection may be detected and/or analyzed. Such a method step may involve a group of activities that use CV algorithms to predict/detect different types of elements in the process diagram image. In some embodiments, multiple concurrent image analysis algorithms may be utilized, each of which may focus on predicting different types of elements in the image. Each detection algorithm may result in the generation of a specific data structure containing the collection of objects or elements in a category/layer. Each predicted element in a layer may describe the element's location and size in the diagram, along with a confidence factor (indicating a level of certainty regarding the prediction(s)). A collection of layers may be passed to the next step in the process.

One layer may be the custom object layer 125. Custom objects may be detected in the source image. In some examples, such detection may be facilitated using a supervised machine-learning-based object detection approach. Relatedly, a machine learning model may be built after identifying and tagging various objects within a large set of process diagram training images. Then the model may be “trained” and tested against a different set of test images, in order to improve predictions. Next, the training and testing may be iterated until related test predictions are sufficiently accurate.

An object prediction algorithm may use the trained custom machine learning model to analyze an image and return a data structure. A data structure may contain information, e.g., about the predicted objects, including position, size, and confidence.

Another layer may be the text object layer 130. In some examples, a CV algorithm may be used to detect text objects found in images. For example, optical character recognition (OCR) may be used to detect text found through the diagram. More specifically, an image may be provided to an OCR algorithm, and a resulting data structure may describe the detected text, such as in terms of position, size, orientation, and confidence. Some embodiments may also utilize a specialty subset focused on handwritten text characters, such as OCR solutions that support intelligent character recognition (ICR) capabilities.

Another layer is the CV line detection layer 135. Relatedly a method embodiment may include the step of predicting one or more element types associated with the detected elements. This may be performed using element predictors, to perform custom object predictions (using, e.g., Azure™ Custom Vision ML), text object predictions (using, e.g., Azure™ Form Recognizer OCR), and/or CV-line detection (using, e.g., OpenCV™ Library).

In addition to detection of the objects/elements and their layers, in some examples, a method step may also include generating an intermediate model 145 using an intermediate model generator 140. In some embodiments, the intermediate model generator 140 may generate an intermediate model 145 based at least in part on the detected elements (or element layers) and/or on the predicted element types. As explained further below, the intermediate model 145 may include containers, nodes, and/or connectors.

In some examples, a method step may also include a model converter 150 for converting the intermediate model to a process model 155. In some embodiments, the process model may be a BPMN 2.0 process model, although other process model types are also within the scope of the disclosure.

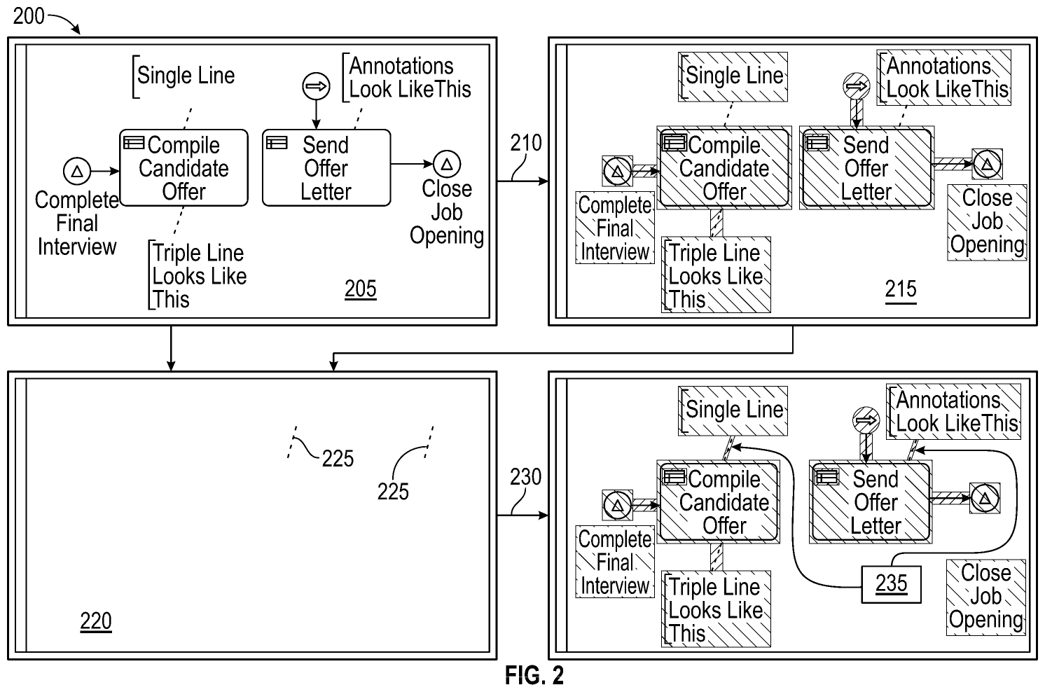

FIG. 2 is a block diagram 200 generally illustrating an embodiment associated with creating a process model, in accordance with aspects of the disclosure. More specifically, FIG. 2 is an illustration of an auxiliary CV-Line detection approach. Similar in some aspects to step 105 of FIG. 1 above, an image (e.g., an original image) may be selected and received at step 205. Next, at step 210, elements of the file(s) or image(s) may be detected, similar in some respects to the step of detecting elements 120 described above with regard to FIG. 1.

Next, in some examples, the detection of lines in the source image may be augmented by employing two or more steps for obtaining line information. One such additional step may be detected object subtraction. Some examples of detected object subtraction may entail creating a copy of the source image, and detecting objects in the image 210 by predicting the known objects to which the detected objects may correspond. Then the pixels in the areas of the image that correspond to most types of predicted objects may be omitted, cleared, or ignored 215. Thus, a remaining (or post-subtraction or reduced) image may contain only the areas that had not yet been predicted 220, which remaining image may often feature only lines 225. Then, this reduced image may be passed to the line detection algorithm (in some examples).

Another additional step may be line detection. Some line detection embodiments involve CV (e.g. OpenCV) to find and detect the remaining lines 230. For example, line detection may involve a OpenCV HoughLines, which may return a series of line segments (PointA-PointB). Such lines that may be detected through CV may then be visually highlighted 235—for example, by being shown in a particular color (e.g., red), or pattern (as shown).

Every hint or indicator that can be gleaned from the source image, and the entire sets of potentially detectable element-types that may impact conversion outcome, are not expressly detailed herein. Nevertheless, such will become apparent to those of ordinary skill in the pertinent arts, in connection with other aspects of the disclosure, in order to create fully functional embodiments capable of converting images containing a wide array of diagrams. For example, some embodiments may be drawn from various diagramming standards, and in such cases, specific elements detected in images (along with the intermediate process model components, as described herein) may be defined according to such standards.

For example, some embodiments may have the objective of creating a BPMN 2.0 model. BPMN 2.0 models may be constructed from nodes and edges. They are informed by BPMN 2.0 diagramming standards; thus, specific elements, along with process model components, may be defined in the BPMN 2.0 specification. BPMN 2.0 element descriptions and categories may accordingly impact operations when synthesizing a BPMN process model from an image or photo. Related embodiments and techniques may be expanded to include every element defined in the BPMN 2.0 specification, and related elements and sets of indicators may be detected in the source image.

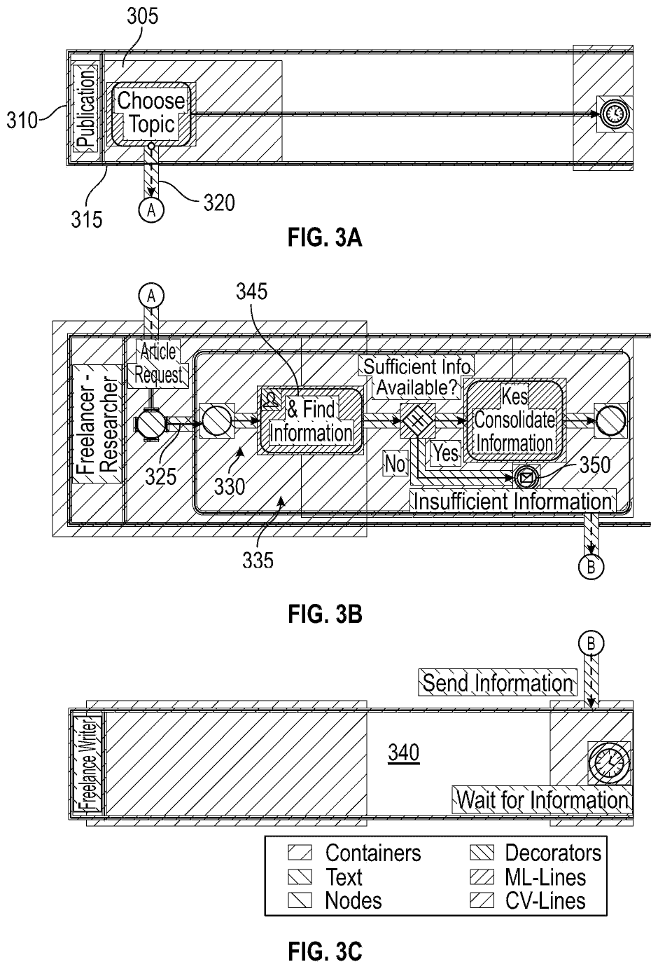

FIGS. 3A-3C may be block diagrams 300 generally illustrating embodiments associated with creating a process model, in accordance with aspects of the disclosure. In some embodiments, each entity in a process model may hold, or have associated with it, descriptions and metadata. Although FIGS. 3A-3C and the other of the following figures and examples may relate to converting images containing BPMN diagrams, other non-BPMN process diagrams can also be converted in similar ways, and by expanding the kinds of elements to be detected and converted to those non-BPMN processes.

FIG. 3A may illustrate some aspects of intermediate model creation or generation. In some embodiments, such generating may be based on the detected element layers. For example, containers—which may be participants, lanes (which may signal participants), and sub-processes—may be detected using elements from multiple layers. More specifically, in some embodiments, participants and lanes 305 may be predicted in the custom object layer with somewhat course (e.g., inaccurate) location/size based on training. In addition, vertically oriented text 310 may provide additional hints (and labels). CV lines 315 may provide the location or outline of boundaries. Further, the presence of dotted-lines 320 may indicate messages and differentiate lanes from stand-alone participants.

FIG. 3B may illustrate some aspects of intermediate model creation or generation, in accordance with aspects of the disclosure. Generation of the intermediate model may also entail sub-processes. For example, arrows/lines 325 on the edges may provide hints/differentiation from lanes 305. In addition, some models such as machine learning (“ML”) models may coarsely predict sub-processes based on training 330. Moreover, in some embodiments, an absence 335 of vertically oriented text 310 may provide differentiation from lanes 305. In addition, similar to FIG. 3A above, CV lines 315 may also provide the location or outline of boundaries for subprocesses.

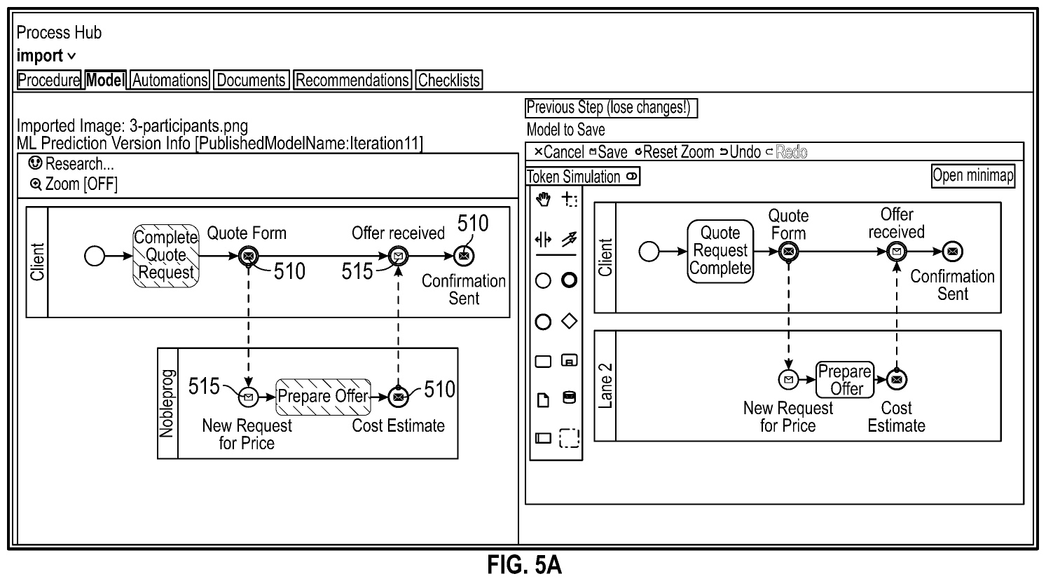

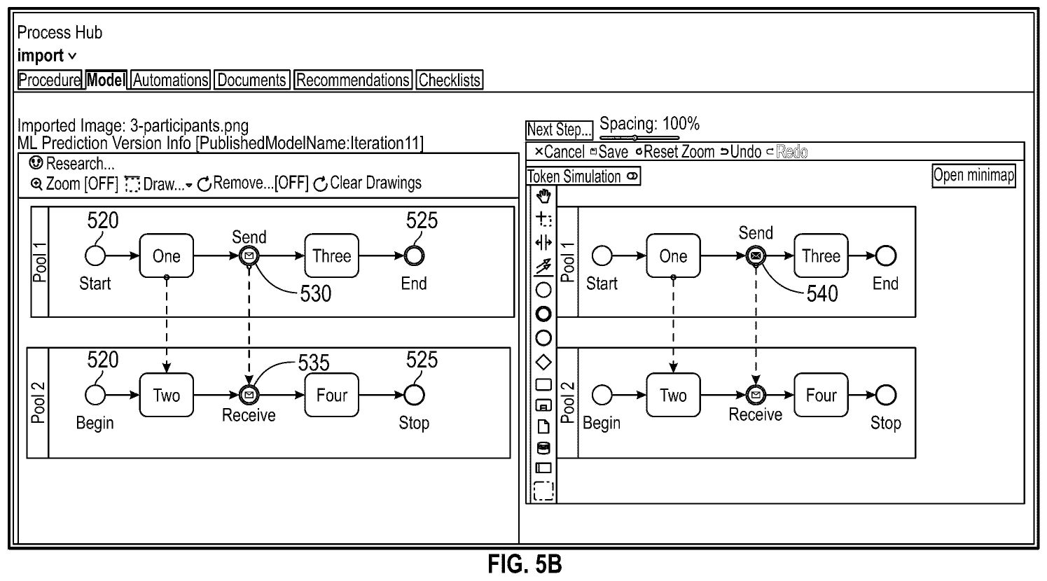

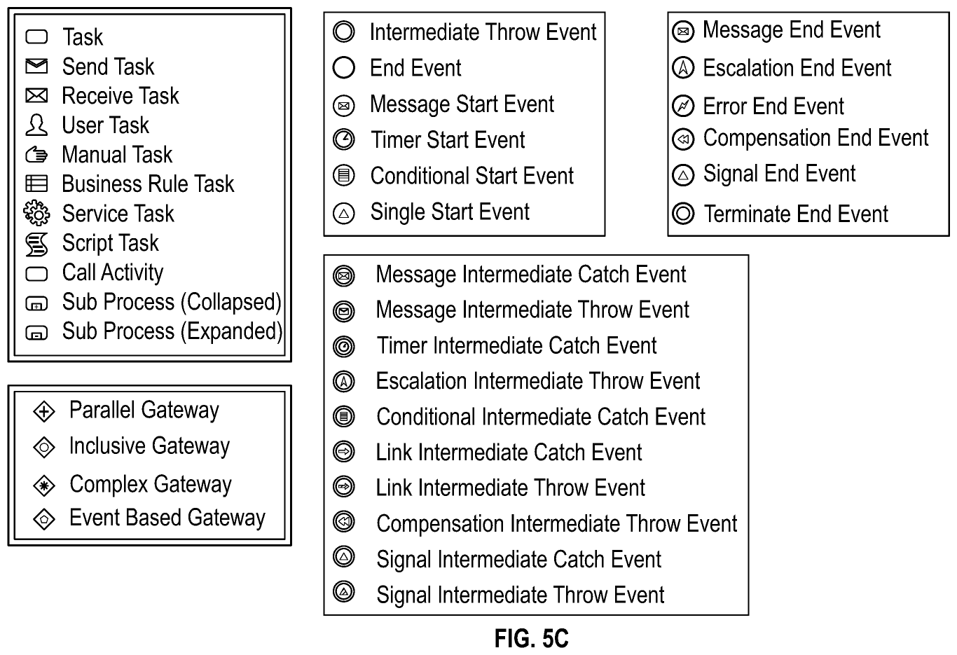

In addition, process nodes (types of which in some embodiments may be defined by various standards, such as BPMN, and not all of which are described here) may form a foundation for process diagrams and process models. In addition to detecting the basis for node objects themselves, ancillary objects in the source image may also be identified and detected. Such ancillary objects may serve as hints to refine the specific types of process nodes in the resulting model and may be referred to as decorators (see FIG. 5C).

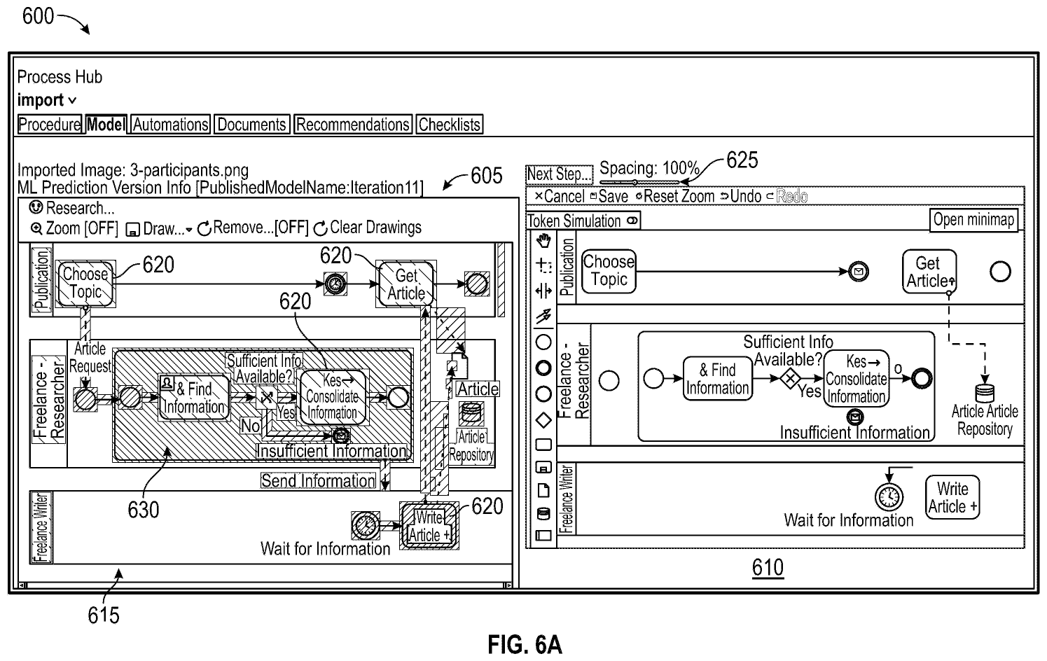

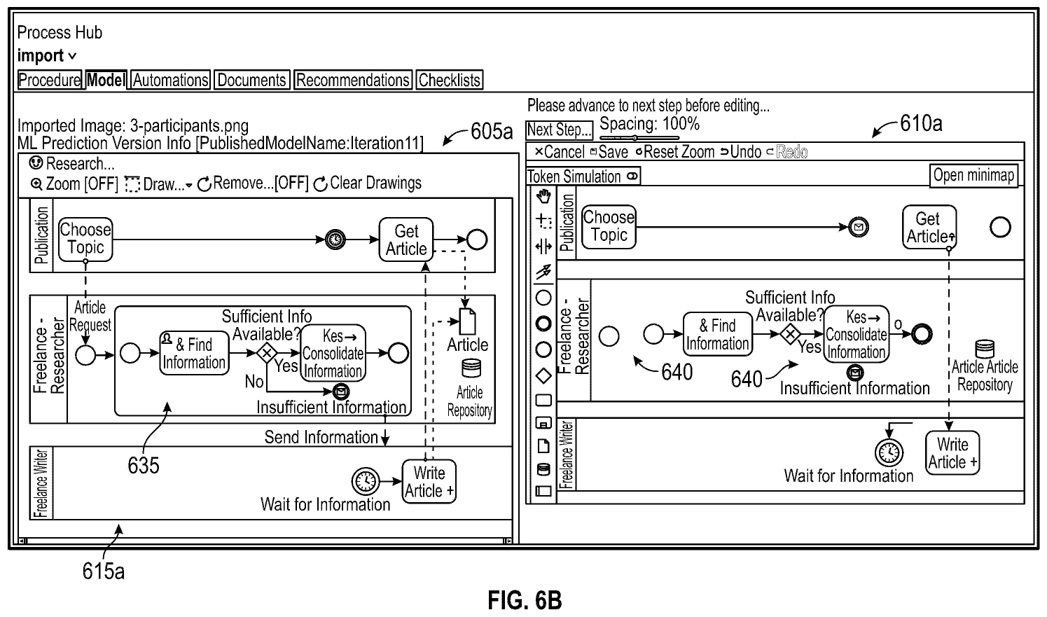

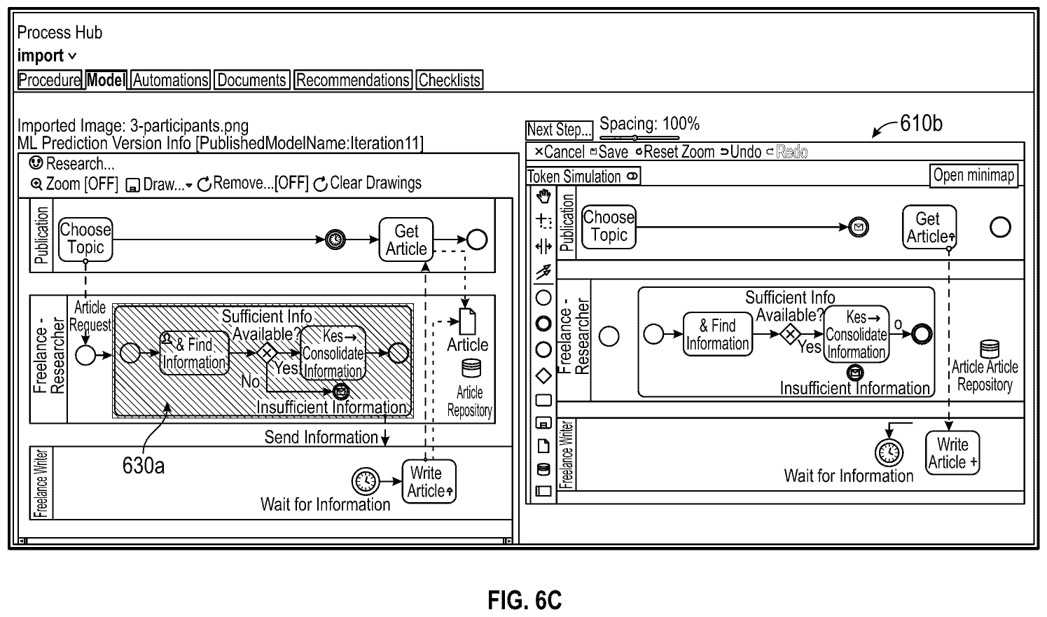

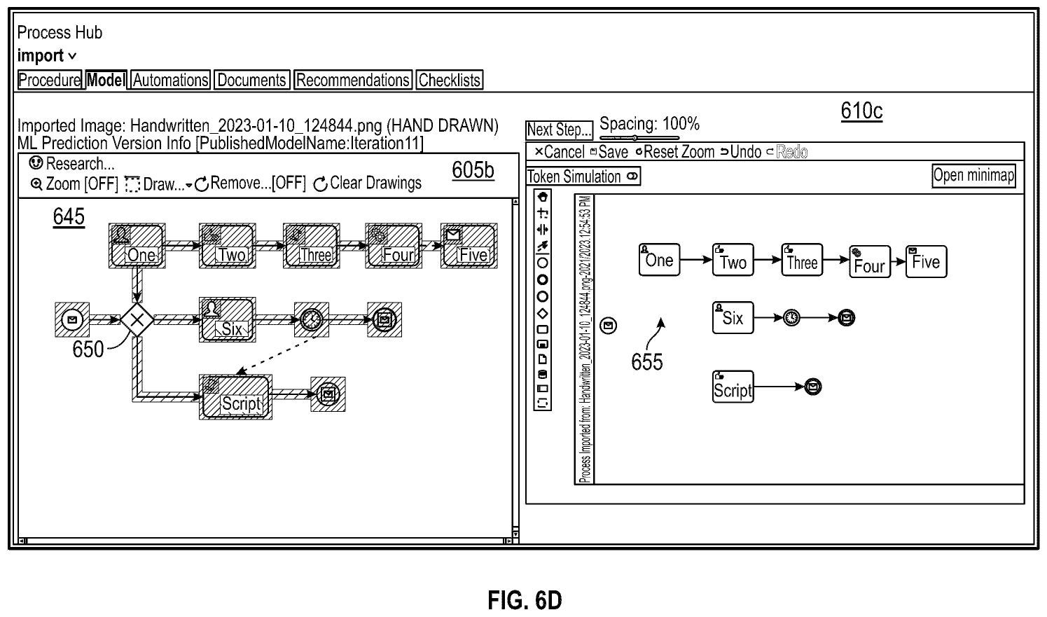

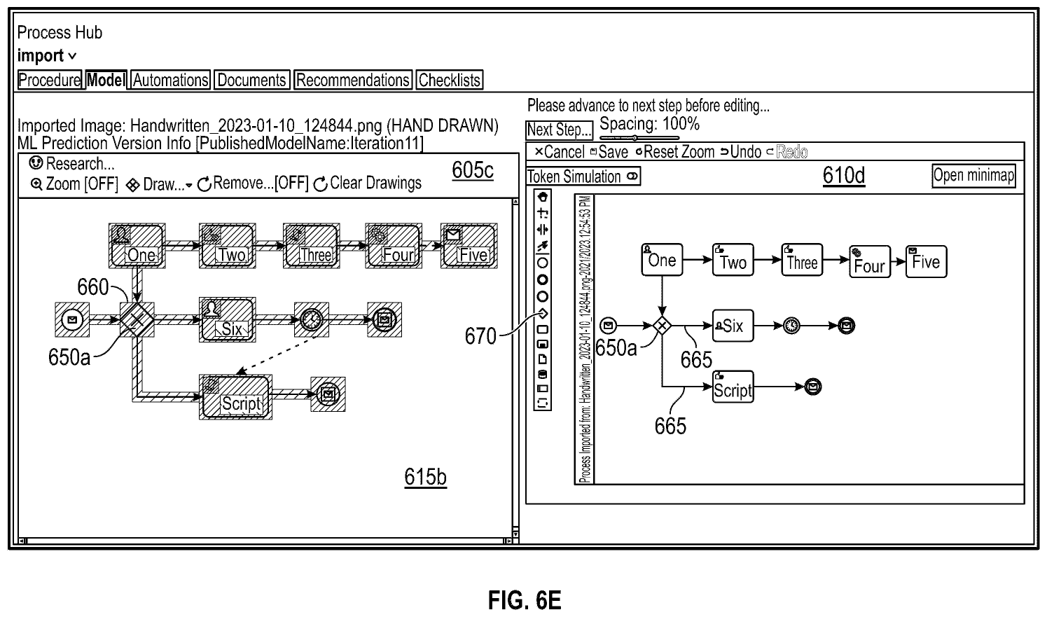

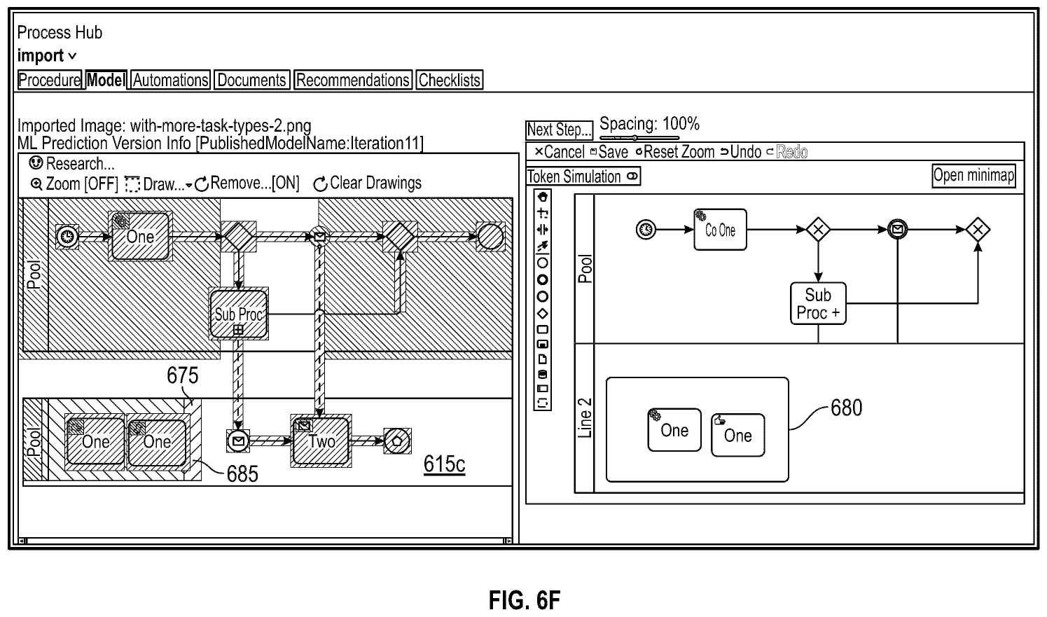

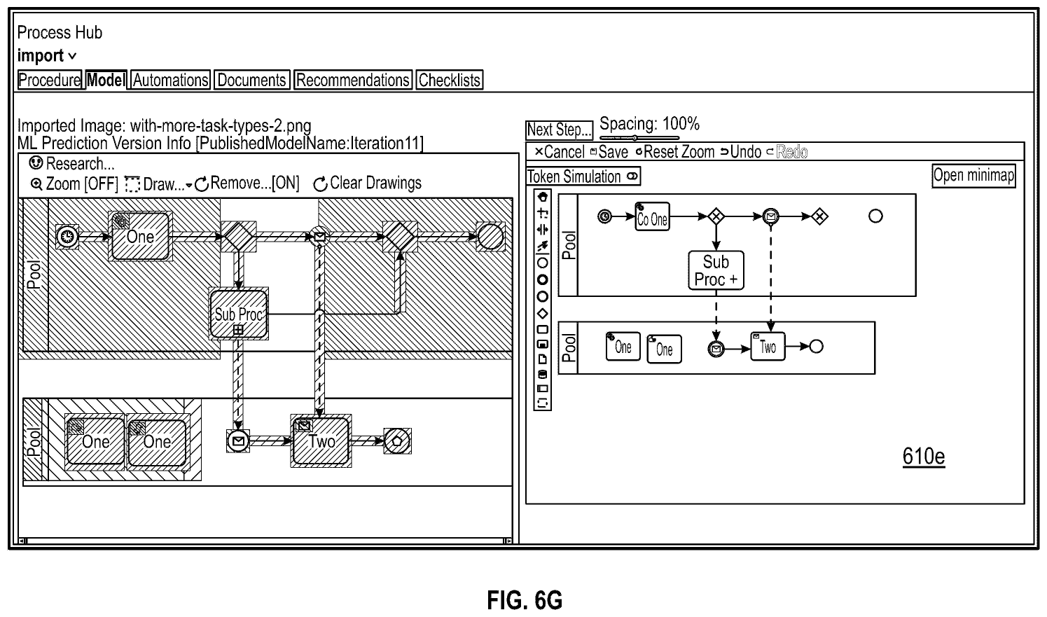

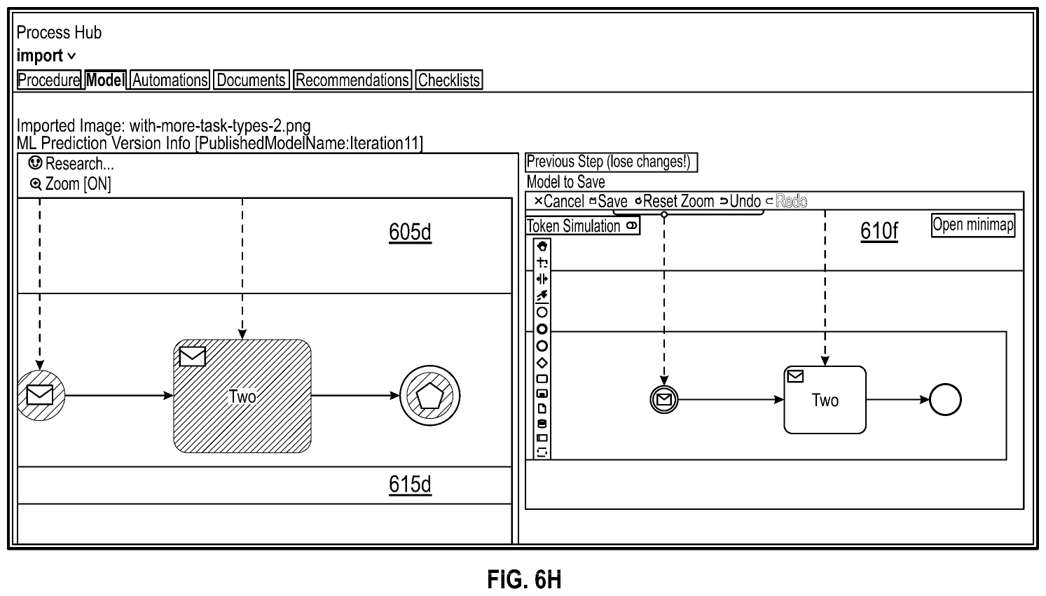

In some embodiments, some decorators may be used in multiple node types. For example, “Message Start Event” and “Receive Task” may both use the same indicator. In some embodiments, that indicator may appear as an email icon, as shown in FIG. 6H (610f).

In such embodiments, when the email icon indicator is detected in the source image, its proximity to the other detected shapes (e.g., an event shape or activity/task shape) may be utilized to increase accuracy of node conversion.

FIG. 3C may illustrate some aspects of intermediate model creation or generation, in accordance with aspects of the disclosure. Similar in some respects to the object detection and subtraction described with regard to FIG. 2, after lanes are detected, the long vertical and horizontal CV-lines that were associated with them may be removed 340 from the object layers for the remainder of the detection/conversion algorithms. Such removal may reduce the likelihood that the lines will be mistakenly reused for subsequent node connector detection.

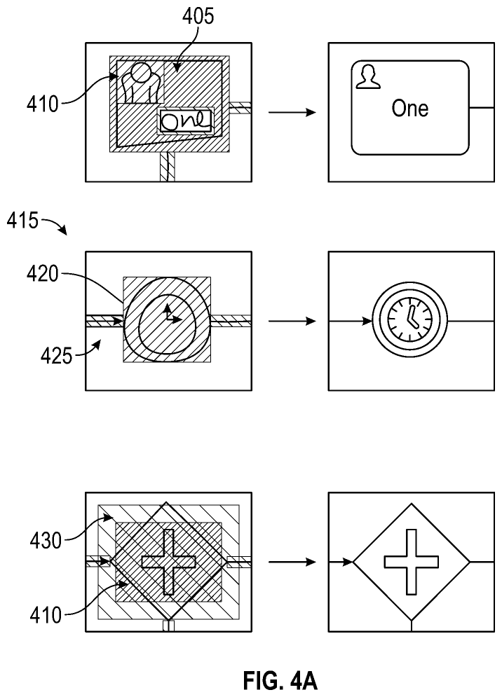

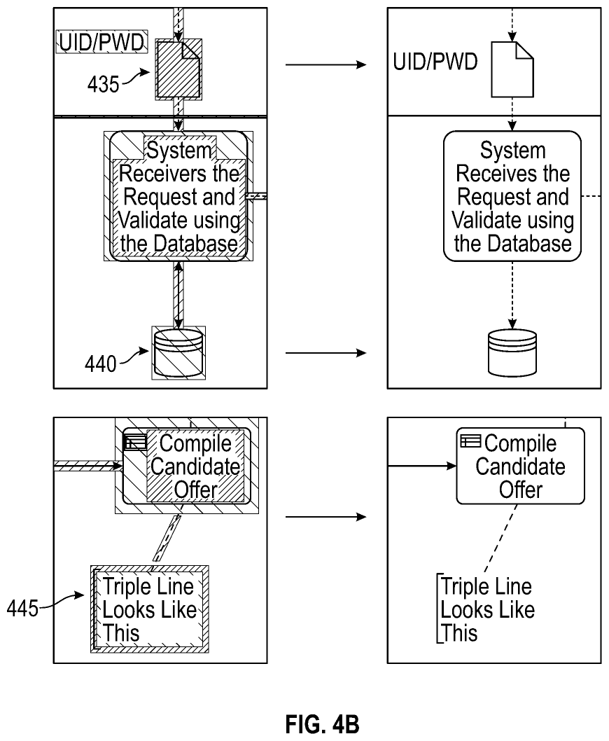

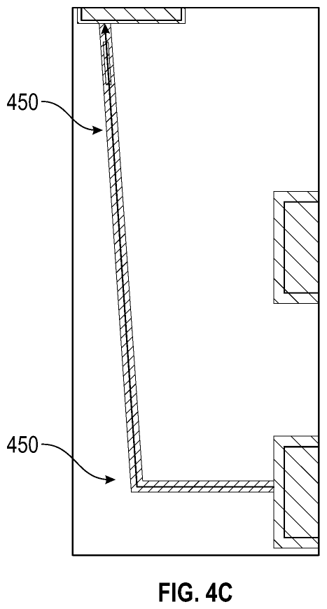

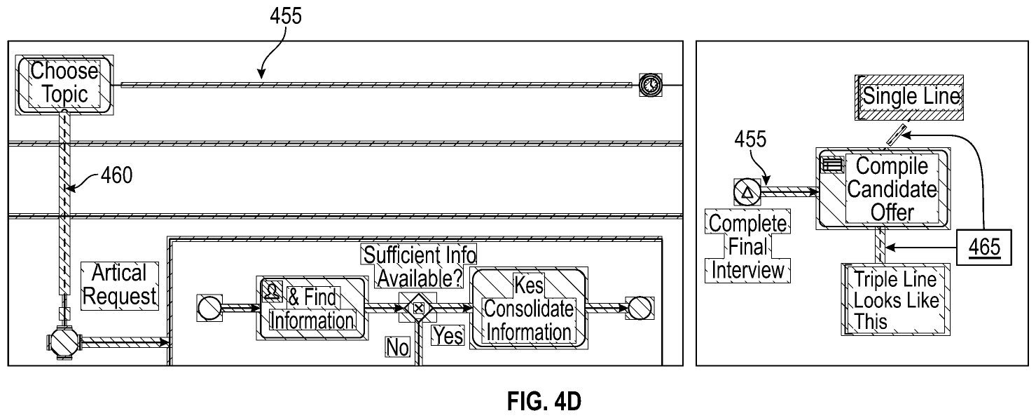

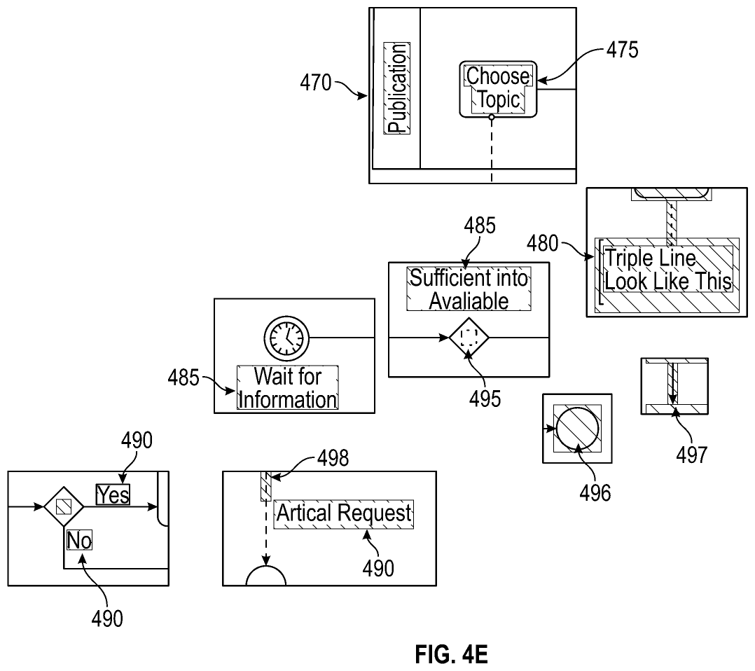

FIGS. 4A-4E may illustrate some aspects of intermediate model creation or generation, in accordance with aspects of the disclosure. More specifically, FIG. 4A may illustrate aspects of the disclosure relating to predicting elements, activities, data objects, and connectors. For instance, activities 405, events 415, and gateways 430 may be predicted in the custom object layer. Also, decorators 410 may be predicted and applied to an activity 405 and/or an event 415 and/or gateway 430 when they intersect with the decorator 410. In addition, a stand-alone decorator 420 may be found without a corresponding event detection; in some embodiments, this may still be interpreted as an event. Further, the presence of adjacent predicted arrows 425 may influence or indicate event type (e.g., start, end, intermediate throw, intermediate catch). In some embodiments, such event type may be based on BPMN rules and conventions.

FIG. 4B may illustrate aspects of the disclosure relating to data objects 435, data stores 440, and annotations 445. For example, custom object layer embodiments may also predict data objects, data stores, and annotations.

FIG. 4C illustrates aspects of the disclosure relating to node connectors 450. Node connectors 450 may be comprised of lines, dotted lines (which in some embodiments, may represent message flows), and arrows, which may also be predicted by either a custom object layer, and/or a CV-lines layer.

Since the location and size information from our custom object layer may not be perfectly accurate, node connection algorithms determine inferences associated with whether connector objects form a complete connection between nodes.

In some embodiments incorporating such algorithms, each connection may be regarded as a connector object group. And each connector object group may be regarded as an array of objects (e.g., arrows, lines, cv-lines) that together may form a connection between two nodes in the process model. In some embodiments, such an array of objects may be associated with, or from, the layered element collection. Some methods for determining how to group the connector objects may involve evaluating each connector object to find near-neighboring connector objects, which may be referred to as “chasing” the connector objects. Once a near-neighbor connector object is identified, it may be added to the connector group, and the chasing algorithm may continue to look for near-neighbors of the first connector object and/or of the second connector object (i.e., the near-neighboring connector object), etc.

FIG. 4D illustrates aspects of the disclosure relating to sequence flows. In some embodiments, sequence flows 455 may be created by using arrow and line objects detected by our custom object layer, plus CV-lines. Message flows 460 may be represented by dotted lines, which may be found in the custom object layer.

Associations 465 may also be represented by dotted lines (which may in some examples vary and/or be distinct from the dotted lines for the messages flows 460). However, any line (dotted or not) that is detected as connecting certain types of nodes may suffice as a valid connection. In addition, in some examples, the process model may automatically represent such valid connections as dotted in the final diagram (e.g., a final BPMN 2.0 diagram).

FIG. 4E illustrates aspects of the disclosure relating to node and connector labels. Labels for nodes and connectors may be found either inside or near those objects. For instance, lane/participant labels 470 may be vertically oriented text found to the left of a lane/participant. In addition, activity labels 475 and annotation labels 480 may be text found inside a node. On the other hand, gateway and event labels 485 may be text found near (but not necessarily inside) a node. In addition, connector labels 490 may be text found directly on, or near the connector.

FIG. 4E also illustrates aspects of the disclosure relating to text filtering. For example, “X” or “+” text 495 may occasionally be found in gateways, “O” text 496 may be found in simple events, “V” text 497 may be found in hand-drawn arrows, and/or “ - - - ” text 498 may be found in dotted/dashed lines. Occasionally, some or all of such text may be filtered out.

FIGS. 5A-5C illustrate some aspects of intermediate model creation or generation, in accordance with aspects of the disclosure. FIG. 5A also illustrates aspects of the disclosure relating to intermediate model adjustments.

Creation of an intermediate model may provide a basic construct of a generalized process model, prior to conversion into a final format process model. Such an intermediate model and construct may facilitate making adjustments. These intermediate model adjustments may allow “fine-tuning” based on information gleaned from the model.

In some embodiments, such adjustments may be made with the assistance of predictors that, e.g., predict general events and event types based on icons. Sometimes predictors may not accurately differentiate, between particular event types—e.g., start, end, intermediate, throw, and catch event types—and therefore need correcting. By way of more specific example, FIGS. 5A-5C show where predictors correctly find decorators that specify most of the events as being message events (by, e.g., identifying the envelope icons 510, 515 in them). Yet some predictors may not differentiate between, for example, throw 510 (black icon) and catch 515 (white icon) event types (as shown in FIG. 5A), or differentiate start 520, end 525, and intermediate 530, 535 event types (as shown in FIG. 5B).

Thus, to improve the conversion, adjustment algorithms may traverse the connections between nodes in the intermediate model and refine various events in the model based on process rules and indications provided by the model itself. For example, events with both an inbound and an outbound execution flow connector may be designated as an intermediate event. In addition, as shown in FIG. 5B, an event sending a message may be designated as a ‘throw’ event 530. On the other hand, as shown in FIG. 5B, an event receiving a message may be designated as a ‘catch’ event 535. In addition, an adjustment algorithm may analyze within individual participants in the model, e.g., to confirm that the farthest-left and farthest-right events in each participant are either start-events 520 (left-most) or end-events 525 (right-most) within each participant.

The intermediate model may be created based on process rules. Some of these adjustments could have been made manually in the resulting process model via the editor on the right. However, not making the adjustments automatically (using, e.g., a particular algorithm) may prevent the model from being fully created before the edit phase. For instance, some created models may violate process rules, and aspects of the disclosure may address this problem. By way of example, sending a message from a message catch (white) event is invalid, so the message arrow connecting the “Quote Form” 510 and “New Request for Price” 515 events, in FIG. 5A would not be supported in the process model on the right since it is invalid. More particularly, the “New Request for Price” 515 event, shown in white, is actually a “throw”/send event, and should be shown in black as such. And therefore the message arrow from “Quote Form” 510 (which is also a throw event shown in black) to “New Request for Price” 515 is invalid—as a throw event typically should be prohibited from sending a message to another throw event. Yet existing drawing programs (e.g., Visio and Lucid) may not enforce such process rules, thereby allowing users to create diagrams that may convey process model intent (as shown in FIG. 5A) that are actually invalid (e.g., by violating process rules).

Accordingly, conversion algorithms associated with converting from static diagrams to true process models, as mentioned in the disclosure, may permit creating more accurate and valid process models (during the conversion). By way of further example, the image shown on the left in FIG. 5B may have been created using Visio, and may define a pair of ‘send’ 530 and ‘receive’ 535 events. But the ‘send’ 530 event is incorrectly expressed as a ‘catch’ (white) instead of a ‘throw’ (black) message event. A conversion routine as described herein may automatically correct the model to reflect process rules, changing the ‘send’ event to the proper ‘throw’ (black) message event type 540. Such rules-based adjustments are a few examples, and other applications are contemplated such as are within the technical grasp of the person of ordinary skill in the relevant arts.

Once an intermediate model has been adjusted based on particular process rules, the model may be converted to a formal process model. That conversion may be influenced by the (if any) third-party libraries employed. For example, the several varying BPMN source code libraries available may result in varying approaches to encoding the model in a way that supports display, editing, etc. In such cases, conversion routing may map the model constructs (nodes, connectors, etc.) from a particular intermediate model format to the library (e.g., a BPMN.IO file found in third-party BPMN library) by determining/utilizing an appropriate API and making corresponding API calls.

In some embodiments, after obtaining a source image, the conversion process may have automated components, and in some embodiments, be fully automated and self-executing. Users may also provide hints and/or configuration settings to improve the automated conversion. These and other aspects of the disclosure provide tangible advantages and constitute substantial improvements over existing technologies for converting images and image files into digital business-process models. For instance, the conversion into the intermediate process model may provide users with a starting point that may save time compared to creating a new process model from nothing.

In some embodiments, the step of converting may include creating a process model in an editable format. And some embodiments (e.g., of refining process models) may include hosting/displaying a process model in an editable format together with an image associated with the (original) file. Accordingly, in some embodiments, the conversion process may also involve a user interface that hosts a resulting process model in an editable form alongside the original image, which might have particular application where the automated conversion of the image is imperfect. For example, FIG. 5B shows an example user interface, with the source image on the left and a resulting BPMN model on the right.

The editable process model user interface may allow the user to inspect the source image and make manual adjustments, which are then implemented to the resulting process model. In some embodiments, the resulting model may then be saved into the process management system. As noted elsewhere in the disclosure, different types of source diagrams may be depicted in source images. Accordingly, the accuracy of the automated prediction algorithms used during conversion may be affected and impaired by the condition of the source image.

FIG. 5C provides examples of decorators, primarily related to BPMN models. FIG. 5C shows how decorators may affect node definition refinement, as described elsewhere in this disclosure and in particular with regard to FIGS. 5A and 5B.

FIGS. 6A-6H illustrate some aspects of generating and refining a process model, in accordance with aspects of the disclosure. In some embodiments, as shown in FIG. 6A, a user interface 600 may be separated into different sides. For example, a first side 610 (e.g., a right side) may display a model that is read-only and not yet editable. In some examples, a second side 605 (e.g., a left side) may show a source image 615 with overlays 620 that highlight the predicted objects, and permit editing.

Relatedly, some embodiments of generating and refining a process model may include two phases or steps (of user experience) associated with the two sides 605, 610 of the user interface 600. In a first phase or step, a user may adjust settings to improve the conversion process by modifying configuration settings or interacting with the source image on the left 605 to provide conversion hints. Such interaction may result in more efficiently and quickly converting a process model than modifying the process model itself. The right side 610 (and as explained in greater detail below) may show a resulting process model, which may be “read-only” during the first phase/step, and “editable” during the second phase/step. Thus, in some examples, a user may interact with an image on the left side during first phase, and then interact with a process model on the right side 610 during the second phase.

For instance, conversion settings may be adjusted, such as the “Spacing” slider 625 on the right side 610, which affects how much space to insert between elements in the process model canvas. Other settings might affect conversion algorithms in other ways. For example, some images might have a busy image background, and/or introduce false (or misleading) CV-lines; thus, one setting embodiment may disable recognition of CV-lines for a specific image, to improve the conversion accuracy for that specific image.

Some embodiments may support one or more types of interactions. For example, some settings embodiments might determine whether to automatically create a participant/lane in the process model for source images. For instance, users may draw rectangle overlays 630 around shapes in the source image to specify how to interpret the shapes. Such interactions may assist in making prediction algorithms more accurate (e.g., where prediction algorithms were inaccurately identifying the shapes.

For example, as shown in FIG. 6B, predictors may fail to or inaccurately predict one or more sub-processes 635 shown in the source image 615a on the left side (as shown by the missing elements 640 of the subprocess 635 on the right side 610a). For instance, while several tasks may be captured correctly, the subprocess containing the tasks may nevertheless not be detected properly. To correct this, algorithms may be directed to encapsulating the tasks in a subprocess, and instructed to do so.

For example, as shown in FIG. 6C, a user may draw a rectangle 630a around the sub-process 635 in the source image 615a. Drawing such a rectangle 630a may be faster than creating a subprocess later and then dragging the tasks into that subprocess, e.g., by manually inserting a sub-process 635 in the process model on the right side 610b using the (e.g., BPMN) canvas. In fact, drawing a subprocess 635 on the left-hand side should result in the subprocess 635 appearing on the right-hand side 610b (with any tasks/events/etc. that are found within the subprocess boundary/rectangle 630a being contained by the subprocess 635).

As shown in FIG. 6D, predictors may also miss or inaccurately fail to predict a gateway 650 (which, e.g., may be decision point in one or more sequence flows) in a hand-drawn diagram 645 (shown on the left side 605b), as shown missing 655 on the right side 610c of the user interface.

Accordingly, as shown in FIG. 6E, a user may draw a rectangle 660 around the gateway 650a in the source image 615b on the left side 605c. Such a drawing 660 may allow the missing gateway 650a to be filled in on the process model on the right side 610d. In addition, in some embodiments, the drawing 660 and the filling in of the missing gateway 650a may allow the connections 665 between the gateway 650a and other objects to be placed (e.g., in an automated manner). Such operations may save a user substantial time when compared to the alternative of manually creating the gateway and all the connections (e.g., using an editor 670 as shown on the right 610d).

As shown in FIG. 6F, users may also select overlays 675 in the source image 615c that indicate predictions that were made by mistake, telling the conversion algorithms to omit them from the process model. For example, in FIG. 6F, a sub-process 680 is predicted by mistake. Thus, the user can click on the ‘sub-process’ overlay 685 in the source image 615c to specify its removal, which may instruct the conversion algorithms to ignore the sub-process overlay 685 when creating the process model (shown on the right side 610e in FIG. 6G).

As part of a second phase, shown in FIG. 6H, the source image 615d is shown without any overlays, and the process model is editable. In some embodiments, the viewports between the two views (shown in the left side 605d and the right side 610f) may be synchronized as a user zooms in/out of the (e.g., BPMN) canvas, allowing the user to see the associated image area on the left side 605d.

In some embodiments, the newly created process model is distinct from a model with merely a static form, or a bare image of a process diagram. That is, rather than simply support graphical diagramming, embodiments may convert a diagram image into a living process (e.g., BPMN 2.0) model. For instance, the living process model may simulate steps of a process and sequence flows, using for example, moving parts that progress through each step or part of a process or sequence.

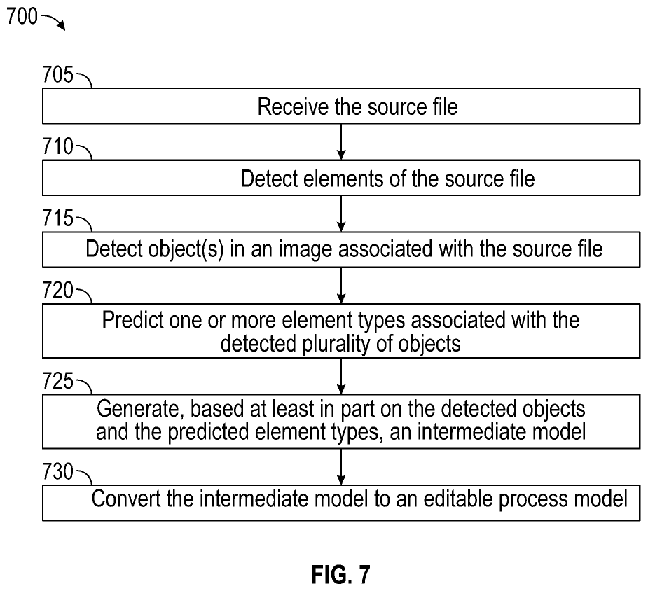

FIG. 7 is a flow diagram generally illustrating a method 700 of process model creation, in accordance with aspects of the disclosure. Such a method 700 may include receiving the source file 705. In addition, the method 700 may include detecting elements of the source file 710. As part of the detecting the elements (or as a separate step) the method 700 may also include detecting one object or a plurality of objects in an image associated with the source file 715. In some embodiments, the detecting elements 720 may involve analysis of element layers and/or involve or be associated with custom object predictions, text object predictions, and CV-line detection.

Further, the method 700 may include predicting one or more element types associated with the detected elements 720. Also, the method 700 may include generating, based at least in part on the detected elements and the predicted element types, an intermediate model 725. And the method 700 may include converting the intermediate model to a formal process model 730.

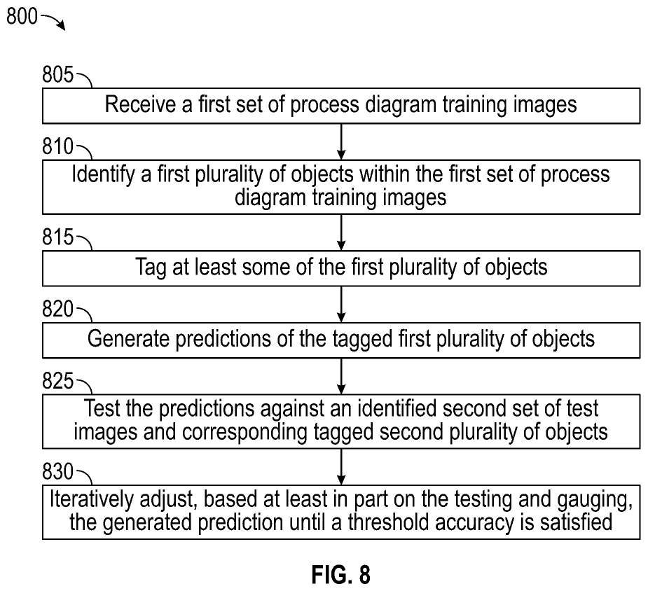

FIG. 8 is a flow diagram generally illustrating a method 800 of building a machine learning model, in accordance with aspects of the disclosure. Such a method 800 may include receiving a first set of process diagram training images 805. Such method 800 may also include identifying a first plurality of objects within the first set of process diagram training images 810. In some embodiments, the receiving may be preceded by selecting (e.g., by a user) a source file, and therefore may be based on such a selection.

In addition, the method 800 may include tagging at least some of the first plurality of objects 815. Further, the method 800 may include generating predictions of the tagged first plurality of objects 820. In some embodiments, the predictions may be associated with element types. In some embodiments, the element types may include or be associated with BPMN element types.

Also, the method 800 may include testing the predictions against an identified second set of test images and corresponding tagged second plurality of objects 825. In some examples, the testing may include gauging the accuracy of the predictions. Moreover, the method 800 may include iteratively adjusting, based at least in part on the testing and gauging, the generated prediction until a threshold accuracy is satisfied 830.

Some embodiments of method 800 may include the step of determining, based at least in part of the iteratively adjusting, an object prediction algorithm for analyzing process diagram images. Some embodiments of method 800 may further include the step of returning a data structure based at least in part on the determined object prediction algorithm. In some such embodiments, the data structure may include data associated with at least one of a position, a size, an orientation, and a confidence level.

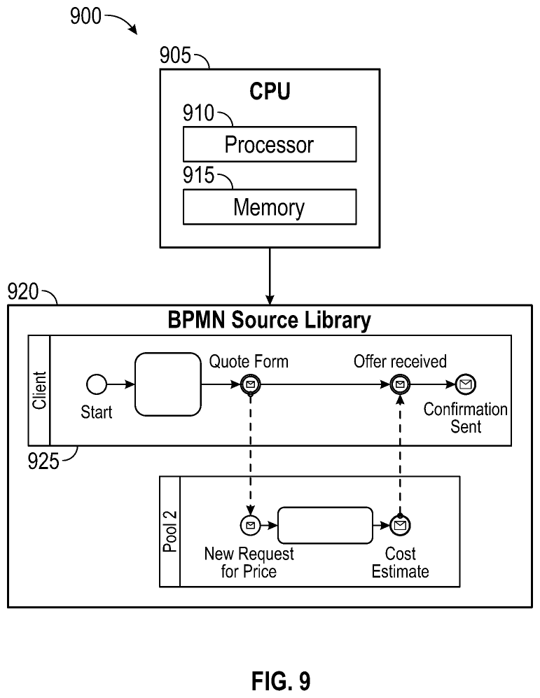

FIG. 9 shows a system 900 in accordance with various aspects of the disclosure. The system 900 may include a computing device 905. The computing device 905 may include a processor 910, and a memory 915. In addition, the computing device 905 may be communicable with a library 920, such as a source code library of a third-party, or included by the computing 905 (not shown). In some embodiments, such as that shown, the library 920 may be a BPMN library. In some embodiments, the library 920 may include a source file 925, such as a source image or a source diagram.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred in any respect. This holds for any possible non-express basis for interpretation, including: matters of logic with respect to arrangement of steps or operational flow; plain meaning derived from grammatical organization or punctuation; and the number or type of embodiments described in the specification.

Some embodiments described in this disclosure may also include a task-engine service that provides centralized management and routing of tasks, including processing, assignment, collection of supplemental data, governance, status, and syncing across all related systems. It may also provide application programming interfaces (“APIs”) through which a user may connect to other task-interaction providers such as Skype, Slack, Salesforce, SharePoint, mobile, application, bots, emails, web forms, etc. The disclosed task-engine service may generate the user interface for each task-interaction provider, and when the user completes the task in one place, it will be automatically updated in all other places in which the task exists. In terms of how this is surfaced: the workflow administrator, by tenant, may configure globally which integrations can be used for tasks; the workflow designer, at a workflow level, may configure where tasks will be surfaced; and the end user may also configure its preferences to determine where tasks may be completed.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

Embodiments of the systems and methods are described with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

Other embodiments may comprise overlay features demonstrating relationships between one more steps, active users, previous users, missing steps, errors in the workflow, analytical data from use of the workflow, future use of the workflow, and other data related to the workflow, users, or the relationship between the workflow and users.

These and other features, and characteristics of the present technology, as well as the methods of operation and functions of the related elements of structure and the combination of parts and economies of manufacture, will become more apparent upon consideration of the description herein and the appended claims with reference to the accompanying drawings, all of which form a part of this specification, wherein reference numerals designate corresponding parts in the various figures. It is to be expressly understood, however, that the drawings are for the purpose of illustration and description only and are not intended as a definition of the limits of the disclosure.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but is not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order; it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

What is claimed is:

1. A method of process model creation, including:
receiving a source file;
detecting elements of the source file, wherein the detecting the elements comprises detecting a plurality of objects in an image associated with the source file;
predicting one or more element types associated with the detected plurality of objects;
generating, based at least in part on the detected plurality of objects and the predicted element types, an intermediate model, wherein the intermediate model comprises a generalized process model construct; and
converting the intermediate model to an editable process model.

2. The method of claim 1, further comprising, before the converting and after the generating, implementing adjustments to the intermediate model.

3. The method of claim 2, wherein the predicted element types comprise a first set of element types but not a second set of element types, and wherein the implementing adjustments is based at least in part on the second set of element types.

4. The method of claim 3, wherein the second set of element types comprise start, end, and intermediate event types.

5. The method of claim 2, wherein the implementing adjustments is based at least in part on enforcing at least one modeling language rule.

6. The method of claim 1, wherein the detecting the elements comprises identifying one or more layers associated with the elements, and distinguishing the elements based at least in part on the identified layers.

7. The method of claim 6, wherein the layers comprise one or more of a custom object layer and a CV-lines layer.

8. The method of claim 7, wherein the editable process model comprises a BPMN model that incorporates modeling rules of BPMN, and wherein the elements comprise one or more of a swim lane, a participant, an arrow, a decorator, an activity, an event, a gateway, a data object, a data store, an annotation, a node connector, a flow, an association, a label, and a filter.

9. The method of claim 1, further comprising:
identifying what of the detected plurality of objects correspond to at least one known predicted object;
subtracting the identified detected plurality of objects that correspond to the at least one known predicted object; and
visually highlighting the remaining detected plurality of objects.

10. The method of claim 1, wherein the converting comprises creating the editable process model in an editable format to receive one or more user-inputted edits; and wherein the method further comprises:
refining the process model, wherein the refining is based at least in part of the received one or more user-inputted edits.

11. The method of claim 10, wherein the refining comprises hosting the process model in the editable format together with displaying an image associated with the source file.

12. The method of claim 1, wherein the source file comprises one or more source embedded or non-embedded images, and wherein the method further comprises:
receiving a selection of the one or more images to extract from the source file.

13. The method of claim 11, wherein the detecting the elements of the source file comprises separately detecting elements of each of the extracted one or more images.

14. The method of claim 1, wherein the predicting comprises:
analyzing at least one of locations of the elements, sizes of the elements, proximity of the elements to each other, and wherein the predicting is based at least in part on the analyzing.

15. The method of claim 1, wherein the source file is received from a source code library, and wherein the receiving the source filed is based at least in part on a selection of the source code library, and wherein the converting is based at least in part on the selected source code library.

16. A non-transitory, computer-readable medium having stored thereon computer-readable instructions that when executed by a computing device cause the computing device to:
receive a source file;
detect elements of the source file based at least in part on a plurality of detected objects in an image associated with the source file;
predict one or more element types associated with the detected plurality of objects;
generate, based at least in part on the detected plurality of objects and the predicted element types, an intermediate model, wherein the intermediate model comprises a generalized process model construct; and
convert the intermediate model to an editable process model.

17. The non-transitory, computer-readable medium of claim 16, wherein the computer-readable instructions further cause the computing device to:
before the converting and after the generating, implementing adjustments to the intermediate model.

18. The non-transitory, computer-readable medium of claim 17, wherein the predicted element types comprise a first set of element types but not a second set of element types, and wherein the implementing adjustments is based at least in part on the second set of element types, and wherein the second set of element types comprise start, end, and intermediate event types.

19. A computing device comprising:
a processor;
a memory; and
a non-transitory, computer-readable medium operably coupled to the processor, the computer-readable medium having computer-readable instructions stored thereon that, when executed by the processor, cause the computing device to:
receive a source file;
detect elements of the source file based at least in part on a plurality of detected objects in an image associated with the source file;
predict one or more element types associated with the detected plurality of objects;
generate, based at least in part on the detected plurality of objects and the predicted element types, an intermediate model, wherein the intermediate model comprises of a generalized process model construct; and
convert the intermediate model to an editable process model.

20. The computing device of claim 19, wherein the computer-readable instructions further cause the computing device to:
before the converting and after the generating, implementing adjustments to the intermediate model; and
wherein the predicted element types comprise a first set of element types but not a second set of element types, and wherein the implementing adjustments is based at least in part on the second set of element types, and wherein the second set of element types comprise start, end, and intermediate event types.
